(19) United States
(12) Patent Application Publication
(10) Pub. No.: US 2024/0316568 A1
(43) Pub. Date: Sep. 26, 2024

(54) SINGLE-SHAFT SHREDDING DEVICE

(71) Applicant: HELIOS CO.,LTD, Kanagawa (JP)

(72) Inventors: Kazuhiko IIJIMA, Kanagawa (JP); Takeshi NAGAO, Kanagawa (JP)

(21) Appl. No.: 17/770,783

(22) PCT Filed: Dec. 16, 2020
(86) PCT No.: PCT/JP2020/048062

§ 371 Date: Apr. 21, 2022

(30) Foreign Application Priority Data
Dec. 19, 2019 (JP) 2019-240153

(51) Int. Cl. B02C 18/14; B02C 18/00; B02C 18/18

(52) U.S. Cl. CPC B02C 18/146; B02C 18/0092; B02C 18/182

(57) ABSTRACT

The shredding device comprises a rectangular housing a rotating shaft which penetrates the lateral the walls of the rectangular housing, a driving unit which rotates said rotating shaft, a plurality of disk-shaped cutters which are detachably mounted on the rotating shaft, each of the disk-shaped cutter has a plurality of cutter U-shaped concaves and which have predetermined-depth at every predetermined interval, a plurality of disk-shaped spacers which are detachably mounted on said rotating shaft, mounted between neighboring two of said disk-shaped cutters and which have a diameter smaller than a diameter of said disk-shaped cutter, and scrapers each of which is mounted on each of longitudinal side walls of said rectangular housing, and is arranged with predetermined gap against circumferences of the disc cutters and circumference of said disk-shaped spacers; wherein each of the disk-shaped cutters has a cutter groove running along its circumference.

### TECHNICAL FIELD

This invention relates to a single-shaft shredding device, and especially relates to the single-shaft shredding device particularly suitable for crushing soft garbage such as used paper diaper.

### BACKGROUND OF THE INVENTION

To recycle soft garbage such as used paper diaper, it is essential to crush it as small as possible and below a predetermined size.

A dual-shaft shredding device shown in Patent Literature 1 has been used previously to crush soft garbage.

The dual-shaft shredding device has two rotating shafts on which cutters and spacers are mounted alternately, and crushes soft garbage by trapping it in the gap between the cutter mounted on one rotating shaft and the spacer mounted on the other.

However, the dual-shaft shredding device shown in Patent Literature 1 has the unavoidable problem that the size of the shredding device will become large because the shredding device requires two rotating shafts.

Furthermore, the gap becomes easily clogged with soft garbage, when the gap between the cutter and the spacer is narrowed for crushing the soft garbage into thinner pieces.

When clogging occurs, not only the shredding device cannot continue operating, because pressing pressure which works against the cutter and the spacer becomes excessively, but also it becomes difficult to uniformly crush garbage into smaller size.

Even though Patent Literature 2 shows a shredding device having a screen at the discharge port to prevent the discharge of soft garbage that has not been crushed enough, this type shredding device becomes difficult to continuously operate due to screen clogging when the shredding device is applied for crushing soft garbage such as paper diaper.

### PRIOR ART LITERATURE

### Patent Literature

Patent literature 1: Japanese unexamined patent application No.2007-209932

Patent literature 2: Japanese patent publication No. 6476532

### SUMMARY OF THE INVENTION

### Problem to be solved by the invention

The purpose of this invention is to solve the above problem, and to provide a single-shaft shredding device that can continuously crush soft garbage equal to or less a predetermined size.

### Means for solving the above problems

A single-shaft shredding device according to the first invention comprises,
a rectangular housing,
a rotating shaft which penetrates the rectangular housing,
a driving unit which rotates the rotating shaft,
a plurality of disk-shaped cutters which are detachably mounted on the rotating shaft, and each of them has a plurality of U-shaped cutter concaves having predetermined depth at every predetermined interval, a plurality of disk-shaped spacers which are detachably mounted on the rotating shaft, and mounted between adjacent two of the disk-shaped cutters, and each of them has a diameter smaller than a diameter of the disk-shaped cutter, and
a plurality of scrapers each of which is mounted on each of side walls of the rectangular housing having predetermined gaps between circumferences of the disc cutters and between circumference of the disk-shaped spacers,
wherein each of the disk-shaped cutters has a cutter groove running along its circumference.

The single-shaft shredding device according to the second invention, wherein each of the spacers has at least one spacer concave on its circumference.

The single-shaft shredding device according to the third invention, wherein the circumferences of the spacers exist outside the bottoms of the U-shaped cutter concave.

The single-shaft shredding device according to the fourth invention, wherein the driving unit rotates the rotating shaft to positive direction and negative direction.

### Effect of the invention

According to the single-shaft shredding device of the first invention, it is possible to miniaturize the size of the shredding device.

Furthermore, even when soft garbage is caught in the gap between the cutter and the scraper, it is possible to suppress the pressing pressure against the housing, and overload of the driving unit. Therefore, the shredding device can continue its stable operation.

According to the single-shaft shredding device of the second invention, it becomes possible to prevent soft garbage from winding to the spacer and piling up on the spacer and the scraper.

According to the single-shaft shredding device of the third invention, it becomes possible to discharge soft garbage which wound to the spacer and piled up on the spacer and the scraper to the cutter concave.

According to the single-shaft shredding device of the fourth invention, it becomes possible to easily continue its operation by switching the rotating direction even when garbage is caught in the gap between the cutter and the scraper and the pressing pressure against the housing increases.

### A BRIEF DESCRIPTION OF THE DRAWINGS

A brief description of the drawings

FIG. 1 is a block diagram of the single-shaft shredding device according to this invention.

FIG. 2 is a top view of the inside of the housing.

FIG. 3 is a longitudinal section view of the inside of the housing.

FIG. 4 is an oblique figure view of the cutter.

FIG. 5 is a front view and a side view of the spacer.

FIG. 6 is an oblique figure in which the cutter and the spacer are overlapped

FIG. 7 is an oblique figure of a rotating body in which cutters and spacers are alternately arranged.

FIG. 8 is an explanatory diagram of the operation.

### EMBODIMENT FOR CARRYING OUT THE INVENTION

Hereinafter, embodiments of the single-shaft shredding device according to this invention will be described with reference to the drawings.

At first, the configuration of the single-shaft shredding device according to this invention will be described.

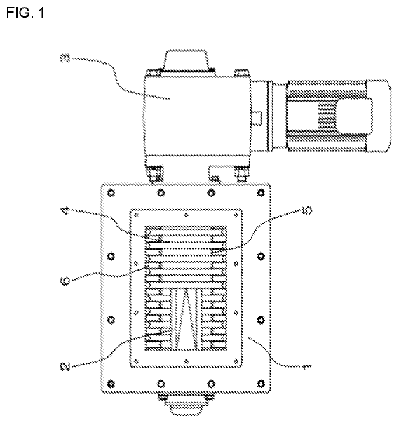

FIG. 1 is a block diagram of the single-shaft type shredding device according to said invention.

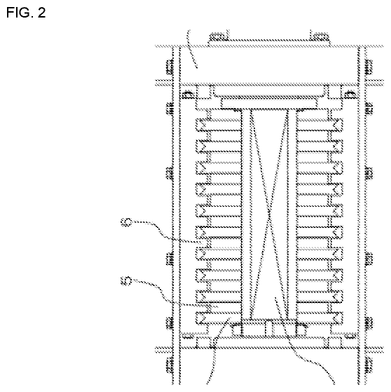

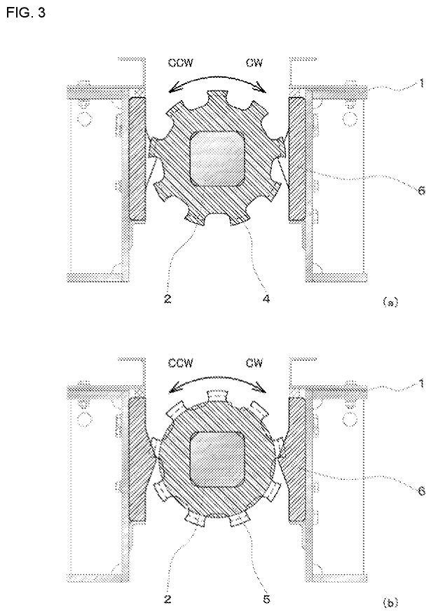

FIG. 2 is a top view of the inside of the housing and FIG. 3 is a vertical sectional view of the inside of the housing.

A single-shaft shredding device according to this invention comprises, a rectangular housing 1, a rotating shaft 2 which penetrate the rectangular housing 1, a driving unit 3 which rotates the rotating shaft 2, disk-shaped cutters 4 which are detachably mounted on the rotating shaft 2 in the housing 1, disk-shaped spacers 5 which are detachably mounted on the rotating shaft 2 in the housing 1, scrapers 6 which are mounted on side walls of the housing 1, and provide predetermined gaps between the circumference of the cutters 4 and between the circumference of the spacers 5 at the level of the center of the rotating shaft 2.

FIG. 3 (a) is cross section of the cutter 4 and the scraper 6. FIG. 3 (b) is a cross section of the spacer 5 and the scraper 6.

The scraper 6 has a triangular protrusion facing the cutter 4 and a flat base facing the spacer 5.

As shown in FIG. 3(a), a predetermined gap is provided between the base portion of the scraper 6 and the outer circumference of the cutter 4.

Further, as shown in FIG. 3(b), a predetermined gap is provided between the top of the projection portion of the scraper 6 and the outer circumference of the cutter 4.

The cutter 4 has U-shaped cutter concaves having predetermined depth at every predetermined interval on the circumference.

The spacer 5 is mounted between two adjacent cutters 4.

That is, the cutters 4 and the spacers 5 are alternately mounted on the rotating shaft 2.

In the embodiment shown in FIG. 1, an electric motor is used as the driving unit 3, but another driving unit such as a hydraulic motor may be applied.

It is desirable that the driving unit can switch between forward rotation and reverse rotation.

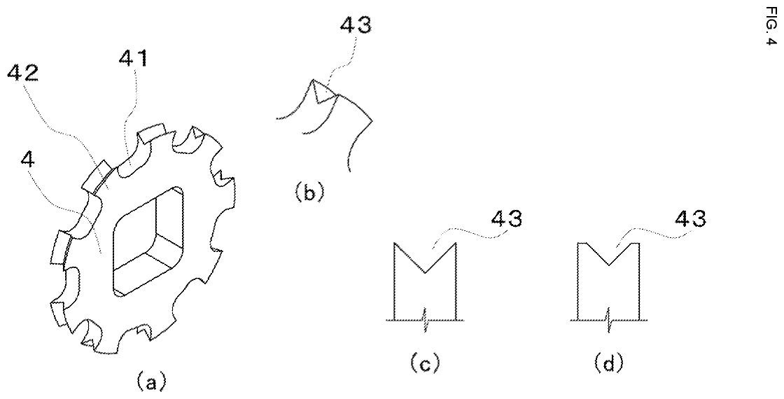

FIG. 4 is an oblique figure of the cutter used in the single-shaft shredding device according to the invention.

That is, as shown in FIG. 4(a), the cutter 4 has a disk-shaped, a fitting hole in the center thereof that is aligned with the rotating shaft 2 at the center, and a plurality of U-shaped cutter concaves at every predetermined interval.

Convex part between two adjacent cutter concaves 41 works as cutter hooks 42.

As shown in FIG. 4(b), a cutter groove 43 running along the circumference is formed on the upper surface of the cutter hook 42, that is, the circumference of the cutter 4.

The outside edges of the cutter groove 43 may have a sharp shape as shown in FIG. 4(c) or a shape that leaves the circumference surface of the cutter as shown in FIG. 4 (d).

The cutter groove 43 may be V-shaped in which both walls form an acute angle at the bottom, or may be U-shaped in which the bottom forms a gentle surface.

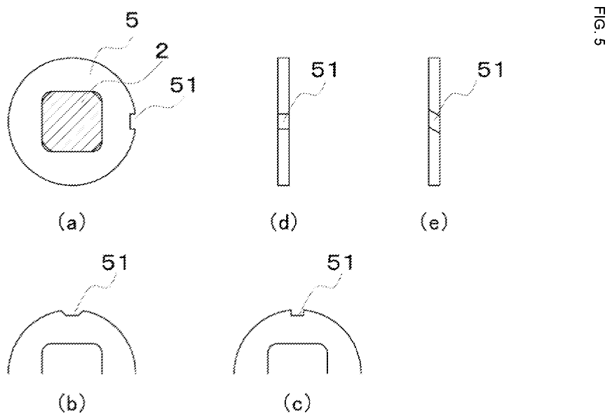

FIG. 5 is a front view and a side view of the spacer used in the single-shaft shredding device according to the invention.

Namely, as shown in FIG. 5(a), the spacer 5 is of the disc-shaped having an outer diameter smaller than that of the cutter 4 and has a fitting hole in the center thereof that is aligned with the rotating shaft 2.

Further, at least one spacer concave 51, which is a groove having a rectangular cross section, is formed on the outer circumference of the spacer 5.

The shape of the spacer concave 51 may be a trapezoidal shape having a short side at the bottom and a long side at the circumference as shown in FIG. 5 (b), or a groove shape as shown in FIG. 5 (c).

Further, the spacer concave 51 may be formed parallel to the rotation axis direction as shown in FIG. 5 (d) or diagonally to the rotation axis direction as shown in FIG. 5 (e).

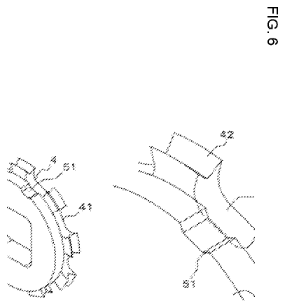

FIG. 6 is an oblique figure in which the cutter and the spacer are stacked.

Namely, the fitting hole of the cutter 4 and the hole of the spacer 5 have the same shape, and the cutters 4 and the spacers 5 are alternately mounted on the rotating shaft 2.

The outer diameter of the spacer 5 is smaller than the outer diameter of the cutter 4, but the circumference of the spacer 5 is set to be outside the bottom of the cutter groove 43 formed in the cutter 4.

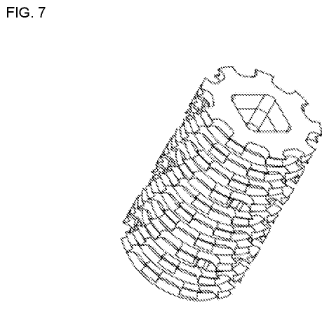

FIG. 7 is an oblique figure of a rotating body in which cutters 4 and spacers 5 are alternately arranged, and it is desirable that the cutter hook 42 are arranged in a spiral shape in direction of the rotating shaft 2. Next, the operation of the single-shaft shredding device according to the invention will be described.

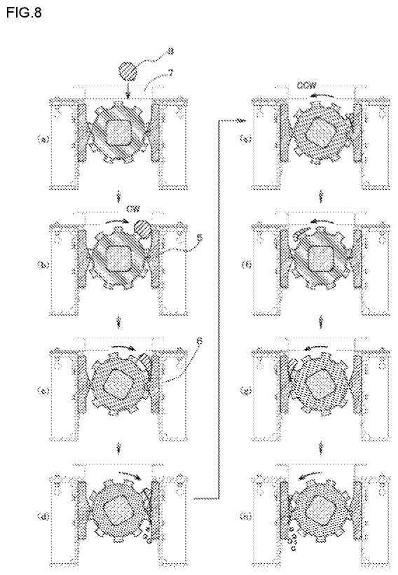

FIG. 8 is an explanatory figure of an operating method of the single-shaft shredding device according to the invention.

First, a case where the rotating shaft 2 of the single-shaft shredding device is rotated clockwise (positive direction) by the driving unit 3 will be described.

Soft garbage 8 such as a paper diaper is charged from the charging port provided in the upper part of the housing 1 (FIG. 8(a)).

The soft garbage 8 is carried to the right side of the housing 1 by the cutter hook 42 (FIG. 8 (b)).

The soft garbage 8 is caught in a gap between the base part of the scraper 6 mounted on the right wall of the housing 1 and the cutter 4, and a shearing of the soft garbage is started (FIG. 8 (c)).

Since a V-shaped cutter groove 43 is provided on the outer circumferential surface of the cutter hook 42, the shredding device can finely crush the soft garbage while suppressing the pressing pressure against the housing 1 even when soft garbage is caught in the gap between the base part of the scraper 6 and the cutter 4 (FIG. 8 (d)).

When the cutter 4 is continuously rotated clockwise to continue crushing of the soft garbage 8, it may become difficult for the driving unit 3 to rotate the rotating shaft 2, because the soft garbage 8 clogs the gap between the cutter 4 and the base part of the scraper 6 and the pressing pressure increases.

In order to prevent the rotating shaft 2 from stopping, the rotating shaft 2 is rotated counterclockwise (negative direction) after rotated clockwise for a time (FIG. 8 (e)).

Then, the soft garbage 8 is carried to the left side of the housing 1 by the cutter hook 42 (FIG. 8 (f)).

The soft garbage 8 is pressed against the base part of the scraper 6 mounted on the left wall of the housing 1 (FIG. 8 (g)), and shearing is started (FIG. 8 (h)).

The rotation direction of the rotating shaft 2 is generally switched at predetermined time intervals.

When the driving unit 2 is an electric motor, the rotation direction may be switched when the current flowing through the electric motor exceeds a predetermined threshold current.

Further, when the driving unit 2 is a hydraulic motor, the rotation direction may be switched when the hydraulic pressure supplied to the hydraulic motor exceeds a predetermined threshold hydraulic pressure.

Namely, by operating the single-shaft shredding device according to the invention as described above, it is possible to continue the operation even when the amount of the soft garbage 8 increases, while suppressing the pressing pressure on the housing 1 from becoming excessive.

Further, by the single-shaft shredding device according to the invention, it is possible to prevent the soft garbage from winding around the spacer 5 and from accumulating on the spacer 5 and the scraper 6, by providing the spacer 5 with at least one spacer concave 51.

As the outer diameter of the spacer 5 is decided so that the outer circumferential edge of the spacer 5 is outside the bottom of the cutter concave 41 provided in the cutter 4, the soft garbage wrapped around the spacer 5 and accumulated on the spacer 5 and the scraper 6 can easily move to the cutter concave 41, and accumulating and winding of the soft garbage 8 can be suppressed.

### INDUSTRIAL APPLICABILITY

The single-shaft shredding device according to the invention can continuously crush soft garbage such as paper diapers to a uniform size, and accordingly has industrial applicability.

### DESCRIPTION OF FIGURES

1 housing
2 rotating shaft
3 driving unit
4 cutter
5 spacer
6 scraper
41 cutter concave
42 cutter hook
43 cutter glove
51 spacer concave

1. A single-shaft shredding device, comprising:
a rectangular housing,
a rotating shaft which penetrates said rectangular housing,
a driving unit which rotates said rotating shaft,
a plurality of disk-shaped cutters which are detachably mounted on said rotating shaft, each of said disk-shaped cutter has a plurality of cutter U-shaped concaves which have predetermined-depth at every predetermined interval,
a plurality of disk-shaped spacers which are detachably mounted on said rotating shaft, mounted between neighboring two of said disk-shaped cutters and which have a diameter smaller than a diameter of said disk-shaped cutter, wherein the circumferences of the spacers exist outside of bottoms of the U-shaped cutter concave, and
scrapers each of which is mounted on each of side walls of said rectangular housing, and arranged with predetermined gap against circumferences of said disc cutters and circumference of said disk-shaped spacers;
wherein each of said disk-shaped cutters has a cutter concave running along its circumference.

2. The single-shaft shredding device according to claim 1,
each of said spacers having at least one spacer concave extended along to the full length of the rotating shaft on its circumference.

3. The single-shaft shredding device according to claim 1,
the circumferences of said spacers exist outside the bottoms of said U-shaped cutter concaves.

4. The single-shaft shredding device according to claim 1,
said driving unit rotates said rotating shaft to positive direction and negative direction.

5. The single-shaft shredding device according to claim 2,
the circumferences of said spacers exist outside the bottoms of said U-shaped cutter concaves.

6. The single-shaft shredding device according to claim 2,
said driving unit rotates said rotating shaft to positive direction and negative direction.

7. The single-shaft shredding device according to claim 3,
said driving unit rotates said rotating shaft to positive direction and negative direction.
